(19) United States
(12) Patent Application Publication
(10) Pub. No.: US 2017/0257583 A1
(43) Pub. Date: Sep. 7, 2017

(54) IMAGE PROCESSING DEVICE AND CONTROL METHOD THEREOF

(71) Applicant: CANON KABUSHIKI KAISHA, Tokyo (JP)

(72) Inventors: Yuki Yoshimura, Tokyo (JP); Akihiko Kanda, Kawasaki-shi (JP)

(21) Appl. No.: 15/445,244

(22) Filed: Feb. 28, 2017

(30) Foreign Application Priority Data
Mar. 1, 2016 (JP) 2016-039156

(51) Int. Cl. H04N 5/367; H04N 5/351

(52) U.S. Cl. CPC H04N 5/367; H04N 5/351

(57) ABSTRACT

An imaging element of an imaging apparatus includes a plurality of microlenses and a plurality of photoelectric conversion units corresponding to the microlenses. A parallax picture having a parallax is generated by acquiring signals from the plurality of photoelectric conversion units. A CPU performs defective pixel detection by calculating an evaluation value from a first output value which is an output value of a detection pixel and a second output value determined from a pixel adjacent to the pixel and comparing the evaluation value with a predetermined threshold value. The CPU calculates a second evaluation value using the second output value and a first evaluation value derived from the first output value and the second output value and detects the pixel as a defective pixel if the second evaluation value is greater than the threshold value.

### BACKGROUND OF THE INVENTION

Field of the Invention

The present invention relates to defective pixel detection of an imaging element.

Description of the Related Art

An imaging apparatus which performs defective pixel detection using information of a pixel adjacent to a target pixel so as to detect a defective pixel within an imaging element has been proposed. In Japanese Patent Laid-Open No. 2010-130236, technology for performing defective pixel detection using information of two or more adjacent pixels of the same color is disclosed. In Japanese Patent Laid-Open No. 2011-97542, technology for performing defective pixel detection using information of pixels of the same color and pixels of different colors is disclosed.

However, an output value of an image signal when the image signal passes through an imaging optical system to reach the imaging element and light of the image signal is received by a photosensor is unlikely to be a uniform value due to an influence of shading. That is, because luminance changes according to a light receiving area of the photosensor due to the occurrence of the shading, it is difficult to appropriately perform defective pixel detection of the imaging element.

### SUMMARY OF THE INVENTION

The present invention provides technology for precisely performing defective pixel detection even when shading has occurred.

A device according to an embodiment of the present invention is an image processing device for acquiring output values of a plurality of pixels and processing image signals, the image processing device including: an acquisition unit configured to acquire a first output value from a pixel and acquire a second output value determined from a pixel adjacent to the pixel; and a detection unit configured to perform defective pixel detection by calculating an evaluation value of the pixel from the first output value and the second output value and comparing the evaluation value with a threshold value. The detection unit calculates a second evaluation value using the second output value and a first evaluation value derived from the first output value and the second output value and detects the pixel as a defective pixel if the second evaluation value is greater than the threshold value.

Further features of the present invention will become apparent from the following description of exemplary embodiments with reference to the attached drawings.

### BRIEF DESCRIPTION OF THE DRAWINGS

FIG. 1 is a schematic configuration diagram of an imaging apparatus in an embodiment of the present invention.

FIG. 2 is a schematic diagram of a pixel array in an embodiment of the present invention.

FIGS. 3A and 3B are a schematic plan view and a schematic cross-sectional view of a pixel in an embodiment of the present invention.

FIG. 4 is a schematic explanatory diagram of a pixel and pupil division in an embodiment of the present invention.

FIG. 5 is a schematic explanatory diagram of an imaging pixel and pupil division in an embodiment of the present invention.

FIGS. 6A and 6B are explanatory diagrams of shading of a parallax picture in an embodiment of the present invention.

FIGS. 7A and 7B are explanatory diagrams of defective pixel detection in an embodiment of the present invention.

FIGS. 8A and 8B are flowcharts from defective pixel detection to picture display in an embodiment of the present invention.

### DESCRIPTION OF THE EMBODIMENTS

Hereinafter, exemplary embodiments of the present invention will be described in detail with reference to the accompanying drawings. An example in which an image processing device according to the present invention is applied to an imaging apparatus such as a digital camera will be described in the embodiments, but the present invention can be widely applied to an information processing device, an electronic device, etc. which execute the following picture processing.

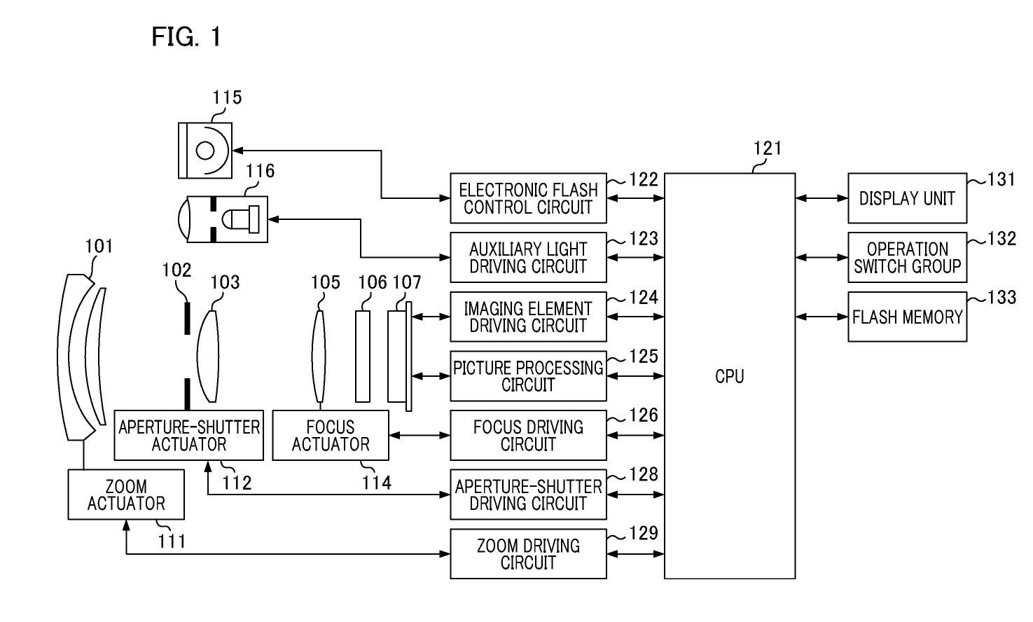

FIG. 1 is a block diagram illustrating an example of a configuration of an imaging apparatus including an imaging element according to the embodiment of the present invention. A first lens group 101 arranged at a distal end of an imaging optical system (a picture forming optical system) is held to be movable forward and backward in an optical axis direction by a lens barrel. An aperture-shutter 102 adjusts the amount of light during photographing by adjusting its opening diameter, and also functions as an exposure time adjusting shutter during still picture capturing. The aperture-shutter 102 together with a second lens group 103 moves forward and backward in the optical axis direction and provides a magnification change effect (a zoom function) in conjunction with the forward/backward movement of the first lens group 101. A third lens group 105 is a focus lens which performs focus adjustment by forward/backward movement in the optical axis direction. An optical low-pass filter 106 is an optical element for reducing false color and moire of a captured picture. An imaging element 107 is constituted of, for example, a two-dimensional complementary metal-oxide-semiconductor (CMOS) photosensor and a peripheral circuit and is arranged in an image formation plane of the imaging optical system.

A zoom actuator 111 performs a magnification-change operation by rotating a cam barrel (not illustrated) to move the first lens group 101 and the second lens group 103 in the optical axis direction. An aperture-shutter actuator 112 controls the opening diameter of the aperture-shutter 102 to adjust the amount of light for photographing and controls the exposure time during still picture capturing. A focus actuator 114 moves the third lens group 105 in the optical axis direction to adjust the focus.

An electronic flash 115 for illuminating an object is used during photographing. A flash illumination device using a xenon tube or an illumination device having a continuous-flash light emitting diode (LED) is used. An auto focus (AF) auxiliary light source 116 projects an image of a mask having a predetermined opening pattern onto the object field through a projection lens. Thereby, focus detection capability for low-luminance objects or low-contrast objects is improved. A central processing unit (CPU) 121 constituting a control unit of a camera body unit has a control center function of controlling the camera main unit in various ways. The CPU 121 includes a calculation unit, a read only memory (ROM), a random access memory (RAM), an analog-to-digital (A/D) converter, a digital-to-analog (D/A) converter, a communication interface circuit, etc. According to predetermined programs stored in the ROM, the CPU 121 drives various types of circuits in the camera and executes a series of operations such as AF control, an imaging process, picture processing, and a recording process. The CPU 121 performs control of defective pixel detection, defective pixel correction, and shading correction of the present embodiment.

An electronic flash control circuit 122 controls the ON operation of the electronic flash 115 in synchronization with a photographing operation according to a control command of the CPU 121. An auxiliary light source driving circuit 123 controls the ON operation of the AF auxiliary light source 116 in synchronization with a focus detection operation according to a control command of the CPU 121. An imaging element driving circuit 124 controls the imaging operation of the imaging element 107 and converts an acquired imaging signal according to A/D conversion to transmit the converted imaging signal to the CPU 121. A picture processing circuit 125 performs processes such as gamma conversion, color interpolation, and Joint Photographic Experts Group (JPEG) compression on the picture acquired by the imaging element 107 according to a control command of the CPU 121. The picture processing circuit 125 performs a process of generating a captured picture or a parallax picture acquired by the imaging element 107. A recording process or a display process is performed on an image signal of the captured picture. Also, the parallax picture is used in focus detection, a viewpoint change process, stereoscopic display, a refocus process, a ghost removing process, etc.

A focus driving circuit 126 drives the focus actuator 114 on the basis of a focus detection result according to a control command of the CPU 121 and moves the third lens group 105 in the optical axis direction, thereby adjusting the focus. An aperture-shutter driving circuit 128 drives the aperture-shutter actuator 112 to control the opening diameter of the aperture-shutter 102 according to a control command of the CPU 121. A zoom driving circuit 129 drives the zoom actuator 111 in response to a zoom operation instruction of the user according to a control command of the CPU 121.

A display unit 131 has a display device such as a liquid crystal display (LCD) and displays information about a photographing mode of the camera, a preview picture before photographing, a confirmation picture after photographing, a focus state display picture during focus detection, etc. As an operation switch, an operation unit 132 includes a power switch, a release (photographing trigger) switch, a zoom operation switch, a photographing mode selection switch, etc. and outputs an operation instruction signal to the CPU 121. A flash memory 133 is a recording medium detachable from the camera body unit and records captured picture data and the like.

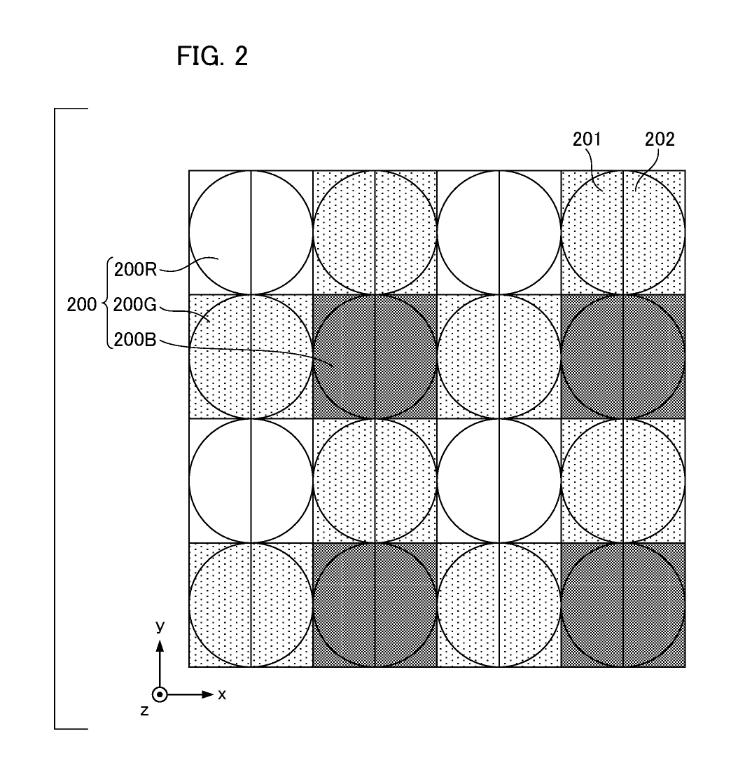

Next, a pixel array of the imaging element in the present embodiment will be described with reference to FIG. 2. FIG. 2 is a schematic diagram illustrating a pixel unit of the imaging element and an array of sub-pixels in the present embodiment. A right/left direction of FIG. 2 is defined as an x-axis direction, an up/down direction is defined as a y-axis direction, and a direction orthogonal to the x-axis direction and the y-axis direction (a direction perpendicular to the paper surface) is defined as a z-axis direction. An example of an imaging pixel array of a two-dimensional CMOS sensor (an imaging element) is shown in a range of 4 columns×4 rows and an example of a focus detection pixel array is shown in a range of 8 columns×4 rows. The imaging pixel is an imaging pixel for outputting an imaging signal and is constituted of a plurality of sub-pixels into which the pixel is divided. In the present embodiment, an example of two sub-pixels into which a pixel is divided in a predetermined direction is shown.

A pixel group 200 of 2 columns×2 rows includes pixels 200R, 200G, and 200B as one set. The pixel 200R (see an upper-left position) is a pixel having spectral sensitivity to red (R) and the pixel 200G (see an upper-right position and a lower-left position) is a pixel having spectral sensitivity to green (G). The pixel 200B (see a lower-right position) is a pixel having spectral sensitivity to blue (B). Further, each pixel is constituted of a first sub-pixel 201 and a second sub-pixel 202 arrayed in 2 columns×1 row. Each sub-pixel has a function of a focus detection pixel which outputs a focus detection signal. In the example illustrated in FIG. 2, a captured image signal and a focus detection signal can be acquired by arranging a large number of pixels of 4 columns×4 rows (sub-pixels of 8 columns×4 rows) on a plane. In the imaging element, a pixel cycle P is assumed to be 4 micrometers (μm) and the number of pixels N is assumed to be about 20,750,000 (=5,575 columns×3,725 rows). Also, an array-direction cycle Pₛ of the focus detection pixel is assumed to be 2 μm, and the number of sub-pixels Ns is assumed to be about 41,500,000 (=11,150 columns×3,725 rows).

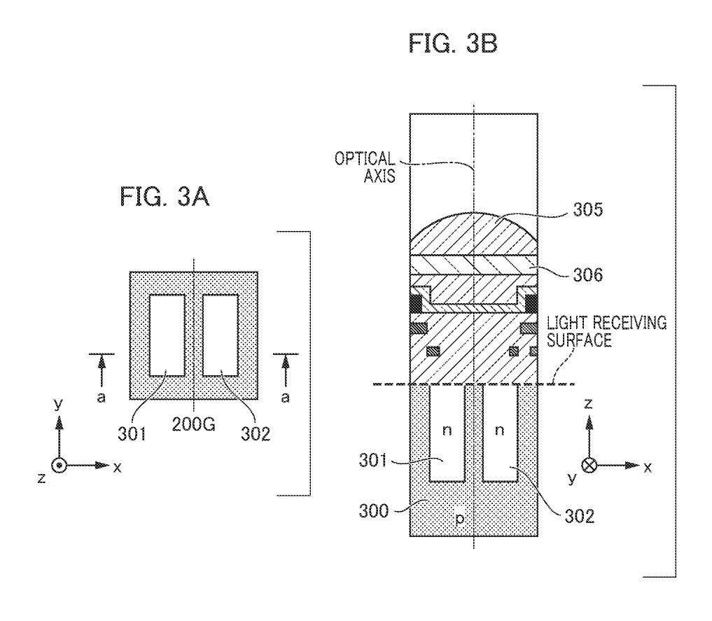

A plan view of one pixel 200G in the imaging element illustrated in FIG. 2 when viewed from a light receiving surface side (+z side) of the imaging element is illustrated in FIG. 3A. A z-axis is set in a direction perpendicular to the paper surface of FIG. 3A and the near side is defined as a positive direction of the z-axis. Also, an up direction is defined as a positive direction of a y-axis by setting the y-axis in an up/down direction orthogonal to the z-axis and a right direction is defined as a positive direction of an x-axis by setting the x-axis in a left/right direction orthogonal to the y-axis. A cross-sectional view when the pixel is viewed from a −y side along the a-a line in FIG. 3A is illustrated in FIG. 3B. The pixel 200G has a microlens 305 for concentrating incident light onto a light receiving surface side (a +z-direction) of each pixel and includes a plurality of divided photoelectric conversion units. For example, the number of divisions in the x-direction is denoted by N_{H} and the number of divisions in the y-direction is denoted by N_{V}. In FIGS. 3A and 3B, an example in which a pupil area is divided into two parts in the horizontal direction, i.e., an example in which N_{H}=2 and N_{V}=1, is illustrated, and photoelectric conversion units 301 and 302 serving as the sub-pixels are formed. The photoelectric conversion unit 301 corresponds to the first sub-pixel 201 which is a first focus detection pixel and the photoelectric conversion unit 302 corresponds to the second sub-pixel 202 which is a second focus detection pixel.

The photoelectric conversion units 301 and 302 may be formed as, for example, photodiodes having a pin structure in which an intrinsic layer is sandwiched between a p-type layer and an n-type layer, or if necessary, may be formed as p-n junction photodiodes by omitting the intrinsic layer. In each pixel, a color filter 306 is formed between the microlens 305 and the photoelectric conversion units 301 and 302. If necessary, spectral transmittance of the color filter 306 may be changed for each sub-pixel and the color filter may be omitted.

After light incident on the pixel 200G is concentrated by the microlens 305 and further separated by the color filter 306, the light is received by each of the photoelectric conversion units 301 and 302. In the photoelectric conversion units 301 and 302, pairs of electrons and holes are generated according to an amount of light and electrons having negative charge are accumulated in an n-type layer (not illustrated) after the pairs of electrons and holes are separated by a depletion layer. On the other hand, the holes are discharged outside the imaging element through the p-type layer connected to a constant voltage source (not illustrated). Electrons accumulated in the n-type layer (not illustrated) of the photoelectric conversion units 301 and 302 are transferred to an electrostatic capacitance unit (FD) via a transfer gate and converted into a voltage signal.

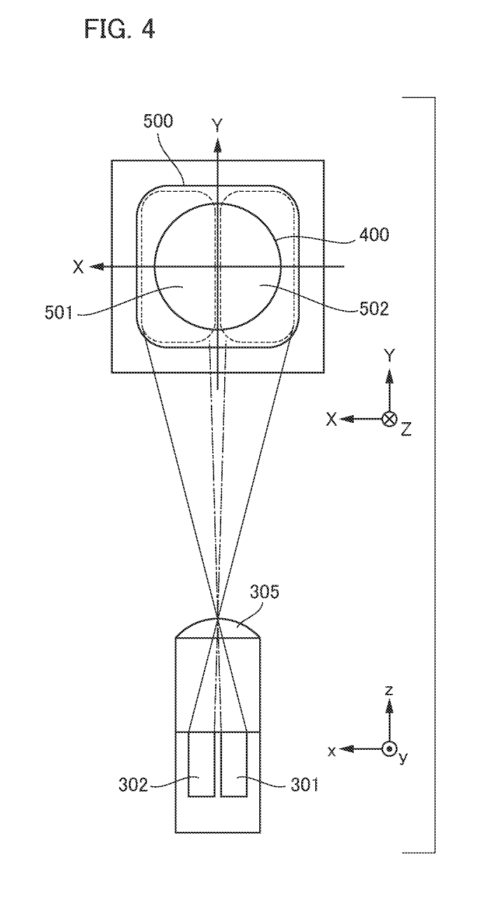

FIG. 4 is a schematic explanatory diagram illustrating a correspondence relationship between a pixel structure and pupil division. In FIG. 4, a cross-sectional view when a cut surface taken along the a-a line of a pixel structure illustrated in FIG. 3A is viewed from an +y-direction and a diagram of an exit pupil plane of the image forming optical system (see an exit pupil 400) when viewed from a −z-direction are illustrated. In FIG. 4, the x-axis and the y-axis obtained by inverting the state illustrated in FIG. 3 are illustrated in the cross-sectional view of the pixel structure to correspond with the coordinate axes of the exit pupil plane.

A first pupil part area 501 corresponding to the first sub-pixel 201 is generally set to be in a conjugate relationship by the microlens 305 with respect to a light receiving surface of the photoelectric conversion unit 301 having a center of gravity biased in the −x-direction. That is, the first pupil part area 501 represents a pupil area capable of being received by the first sub-pixel 201 and has a center of gravity biased in the +X-direction on the pupil plane. In addition, a second pupil part area 502 corresponding to the second sub-pixel 202 is generally set to be in a conjugate relationship by the microlens 305 with respect to a light receiving surface of the photoelectric conversion unit 302 having a center of gravity biased in the +x-direction. The second pupil part area 502 represents a pupil area capable of being received by the second sub-pixel 202 and has a center of gravity biased in the −X-direction on the pupil plane. In addition, an area 500 illustrated in FIG. 4 is a pupil area in which light can be received by the entire pixel 200G when the photoelectric conversion unit 301 and the photoelectric conversion unit 302, i.e., the first sub-pixel 201 and the second sub-pixel 202, are combined.

The incident light is concentrated at a focus position by the microlens. However, because of an influence of diffraction due to the wave nature of light, the diameter of alight concentration spot cannot be less than a diffraction limit Δ and has a finite magnitude. While a light receiving surface size of the photoelectric conversion unit is about 1 to 2 μm, a light concentration spot size of the microlens is about 1 μm. Thus, the first and second pupil part areas 501 and 502 of FIG. 4 in a conjugate relationship through the light receiving surface of the photoelectric conversion unit via the microlens are not clearly divided due to diffraction blur and have a light receiving rate distribution (a pupil intensity distribution).

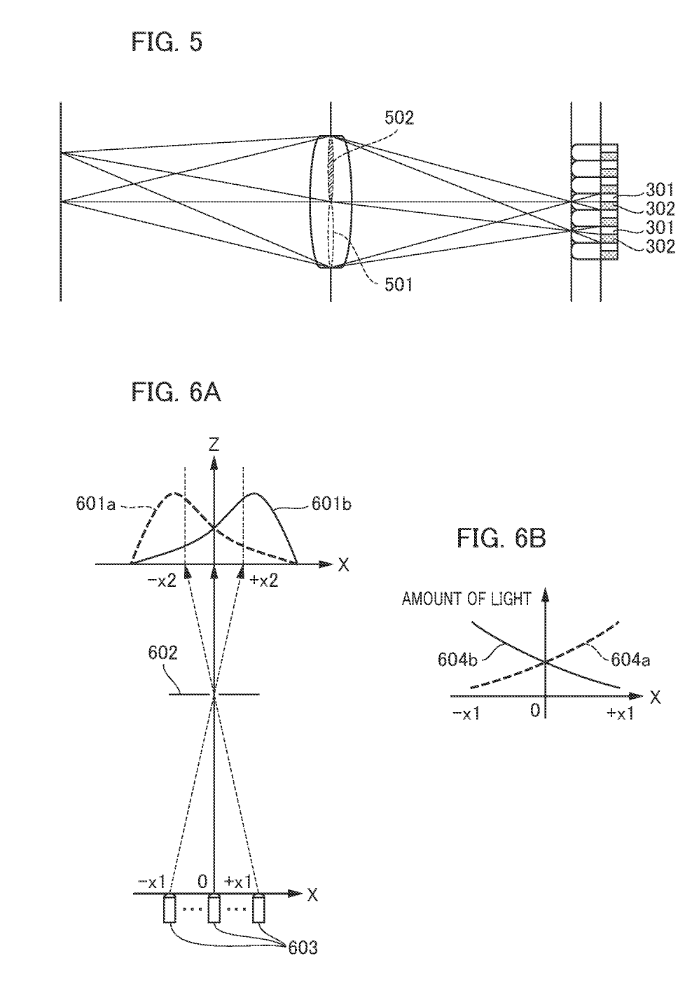

A correspondence relationship between the imaging element and the pupil division is illustrated in a schematic diagram of FIG. 5. Light beams passing through different pupil part areas which are referred to as the first pupil part area 501 and the second pupil part area 502 are incident on pixels of the imaging element at different angles. Each of the photoelectric conversion unit 301 of the first sub-pixel 201 and the photoelectric conversion unit 302 of the second sub-pixel 202 in N_{H} (=2)×Nᵥ (=1) divisions receives incident light to perform photoelectric conversion. An example in which the pupil area is divided into two parts in the horizontal direction has been described in the present embodiment, but the pupil may be divided in a vertical direction, if necessary.

As described above, the imaging element of the present embodiment has a structure in which a plurality of pixel units are arrayed, wherein each of the plurality of pixel units has a plurality of sub-pixels for receiving light beams passing through different pupil part areas of an image forming optical system. For example, signals of the sub-pixel 201 and the sub-pixel 202 are summed and read for each pixel of the imaging element, so that the CPU 121 and the picture processing circuit 125 generate a captured picture with resolution of the number of effective pixels. In this case, the captured picture is generated by combining received light signals of a plurality of sub-pixels for each pixel. Also, in another method, a first parallax picture is generated by collecting received light signals of the sub-pixels 201 of each pixel unit of the imaging element. A second parallax picture is generated by subtracting the first parallax picture from the captured picture. If necessary, the CPU 121 and the picture processing circuit 125 generates the first parallax picture by collecting received light signals of the sub-pixels 201 of each pixel unit of the imaging element and generates the second parallax picture by collecting received light signals of the sub-pixels 202 of each pixel unit. It is possible to generate one or more parallax pictures from the received light signals of the sub-pixels for each of different pupil part areas.

A parallax picture is a picture having a different viewpoint from a captured image, shading correction to be described below is performed, and pictures at a plurality of viewpoints can be simultaneously acquired. In the present embodiment, each of a captured picture, a first parallax picture, and a second parallax picture is a picture of a Bayer array. If necessary, a demosaicing process may be performed on a captured picture, a first parallax picture, a second parallax picture of the Bayer array.

Shading will be described with reference to FIGS. 6A and 6B. FIGS. 6A and 6B are explanatory diagrams of the principle of occurrence of shading of a parallax picture and the shading. Hereinafter, an image signal acquired from the first photoelectric conversion unit in each pixel unit of the imaging element is designated as an image signal A and an image signal acquired from the second photoelectric conversion unit is designated as an image signal B. FIG. 6A illustrates an incident angle light reception characteristic 601a of the image signal A and an incident angle light reception characteristic 601b of the image signal B. The horizontal axis represents a position coordinate X and the vertical axis (Z-axis) represents light reception sensitivity. FIG. 6A also illustrates an exit pupil frame (an exit pupil shape) 602 and an imaging pixel 603 of each image height. A position of +x1 corresponds to a position of −x2 on the pupil coordinate and a position of −x1 corresponds to a position of +x2 on the pupil coordinate. FIG. 6B illustrates a graph line 604a indicating the shading of the image signal A in the state of FIG. 6A and a graph line 604b indicating the shading of the image signal B. The horizontal axis represents a position coordinate X and the vertical axis represents an amount of light.

In FIG. 6A, the imaging pixel 603 having an image height of −x1 receives light from a pupil of the position of +x2 on the pupil coordinate through the exit pupil frame 602. Thus, as can be seen from an incident angle light reception characteristic 601a and an incident angle light reception characteristic 601b, the image signal B has higher sensitivity than the image signal A when sensitivities of the image signal A and the image signal B are compared. On the other hand, the imaging pixel 603 having an image height of +x1 receives light from a pupil of the position of −x2 on the pupil coordinate through the exit pupil frame 602. Thus, the image signal A has higher sensitivity than the image signal B when sensitivities of the image signal A and the image signal B are compared. For this reason, shading in the state of FIG. 6A occurs as indicated by graph lines 604a (image signal A) and 604b (image signal B) of FIG. 6B. Because the shading has a characteristic which changes according to a position or a magnitude of the exit pupil frame 602, the state of the shading also changes if an exit pupil distance and an aperture value change. Because vignetting occurs in a real imaging optical system, changes in the exit pupil distance and the aperture value due to an image height of the imaging pixel are different according to an imaging optical system. Consequently, it is necessary to perform correction in consideration of an influence of the vignetting for each photographing condition of the imaging optical system so as to implement highly precise shading correction.

In the case of a lens exchange type imaging apparatus, shading correction corresponding to a lens device mounted on a main body unit of the imaging apparatus is performed. That is, it is necessary to pre-store a shading correction value according to imaging optical system information of the lens device in the main body unit of the imaging apparatus so as to perform the shading correction during picture recording. This is to perform picture recording at high speed so that the continuous photographing performance of the imaging apparatus is prevented from being lost. However, a method of storing all shading correction values according to imaging optical system information for each lens device in a memory requires a huge data storage area and is not practical. Therefore, shading correction is performed by acquiring data necessary for the shading correction during picture reproduction in which the rapidity of the shading correction is not required after picture acquisition. On the basis of information related to vignetting of incident light by the imaging optical system and a sensitivity characteristic of the pixel according to an angle change of the incident light, a correction value for use in the shading correction can be calculated by combining information thereof.

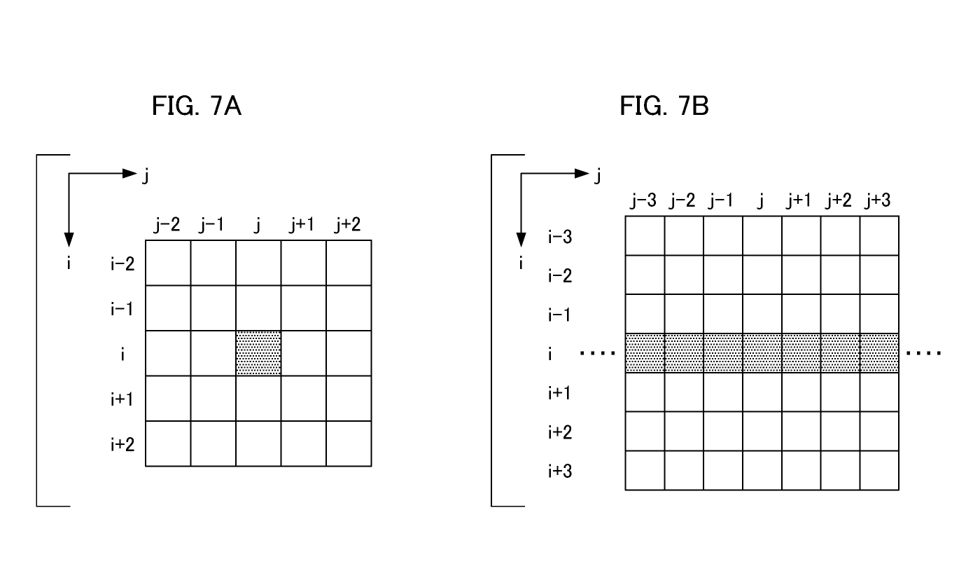

Next, defective pixel detection will be described with reference to FIGS. 7A and 7B. FIGS. 7A and 7B are explanatory diagrams of a method of calculating and evaluating a difference value between an output value (a first output value) of a detection pixel and an output value (a second output value) of a peripheral pixel adjacent to the detection pixel when the defective pixel detection is performed. The second output value is determined by calculating one or more of the first output value, a color filter of a pixel, a pupil area through which a received light beam passes, and the number of added pixels as the same condition. FIG. 7A illustrates a case in which defective pixel detection is performed using an area of adjacent 5×5 pixels. FIG. 7B illustrates a case in which defective pixel detection is performed using an area of adjacent ±3 rows (an area of 7×7 pixels). A position of each pixel is represented using integer variables i and j. In FIG. 7, a pixel position of the vertical direction is indicated by the variable i, a pixel position of the horizontal direction is indicated by the variable j, and a pixel position is indicated by (i,j).

If an output value of the pixel is denoted by S, S includes a signal component S_{typ} and a noise component N. Further, the noise component N includes a fixed noise component N_{fixed} and a random noise component N_{random}. Consequently, the output value S is represented by the following Formula (1).

S=S_{typ}+N_{fixed}+N_{random} (1)

The fixed noise component N_{fixed} is constantly output as an error of a fixed value. The random noise component N_{random} is output as an error which changes according to a magnitude of the signal component S_{typ}. If the fixed noise component N_{fixed} is large, it is necessary to precisely detect a pixel having the large fixed noise component N_{fixed} in the defective pixel detection because the color of the picture changes and appears at all times.

The fixed noise component N_{fixed} is a component affected by gain (denoted by α) with respect to the signal component S_{typ} as shown in the following Formula (2), and the defective pixel detection is performed to mainly detect such a component.

N_{fixed}=S_{typ}·α (2)

α: Pixel variation error.

On the other hand, the random noise component N_{random} is a component which changes on the basis of a Poisson distribution in proportion to the square root of the signal component S_{typ} as shown in the following Formula (3).

N_{random}=β·\sqrt{S_{typ}}·f(t) (3)

f(t): Function which changes in a range of ±1 at photographing time t

β: Sensor-specific value

To determine whether there is a defective pixel by mainly detecting the fixed noise component N_{fixed} in the defective pixel detection, the detection is performed in a condition in which shading is not possible and measurement is performed by reducing the random noise component N_{random}. However, it is difficult to remove all of the random noise component N_{random}. Thus, a process of setting an allowed value of each of the fixed noise component N_{fixed} and the random noise component N_{random} is performed and a threshold value is determined on the basis of a sum thereof.

As one general method of the defective pixel detection, there is a method using a difference value between a representative value obtained by selecting a peripheral pixel adjacent to a pixel as a detection target or a representative value calculated using the adjacent peripheral pixel and an output value of a defect detection pixel. Because a signal component of a case in which a noise component is not included is not actually known, the representative value is used as the signal component. A process of evaluating whether the difference value based on the representative value can be allowed is performed.

A position indicated by a pixel position (i,j) in FIG. 7A indicates a target pixel on which the defective pixel detection is performed. Its output value is denoted by S (i, j). If a representative value in an area illustrated in FIG. 7A, i.e., a median value of output values of 5×5 pixels, is designated as a representative value, it is denoted by S_{typ}. In place of the median value, a mean value or the like may be used. A method of setting the representative value is arbitrary.

An evaluation value of general defective pixel detection (a first evaluation value) is denoted by a function E(i,j,t) of a pixel position (i,j) and the photographing time t. An output value of the pixel is denoted by S(i,j,t). The first evaluation value is calculated by dividing an absolute value of a difference between the first output value and the second output value by the second output value. The following Formula (4) using a predetermined threshold value Eerror is used.

$$E ( i , j , t ) = \frac{\vert S ( i , j , t ) - {S}_{typ} ( i , j ) \vert}{{S}_{typ} ( i , j )} \leq \frac{β}{\sqrt{{S}_{typ} ( i , j )}} + α = Eerror \qquad ( 4 )$$

If a predetermined threshold value in a certain standard output value (denoted by S_{std}) is denoted by Eerror₀ and an allowed variation error is defined as α₀, the predetermined threshold value Eerror₀ from Formula (4) becomes the following Formula (5).

$${Eerror}_{0} = \frac{β}{\sqrt{{S}_{std}}} + {α}_{0} \qquad ( 5 )$$

In the defective pixel detection, it is determined that the target pixel is a defective pixel if the evaluation value E exceeds the predetermined threshold value Eerror₀. That is, defective pixel detection is performed using the following Formula (6).

$$E ( i , j , t ) = \frac{\vert S ( i , j , t ) - {S}_{typ} ( i , j ) \vert}{{S}_{typ} ( i , j )} > {Eerror}_{0} = \frac{β}{\sqrt{{S}_{std}}} + {α}_{0} \qquad ( 6 )$$

Formula (6) is normalized in luminance. That is, the evaluation value E is a normalized luminance evaluation value. If a change in luminance is in a range of several %, it is possible to precisely perform defective pixel detection because a change of S_{typ}(i,j) is considered to be very small. However, a difference in transmittances of color filters of R, G, and B pixels or a difference in shading illustrated in FIG. 6 is not included on the order of several %. Particularly, if Formula (6) is used in a state in which there is an influence of shading, it is difficult to ensure detection precision because S_{typ}(i,j) changes for each area.

If a lens exchange type camera or the like performs photographing at various exit pupil distances, the defective pixel detection should be performed in real time. In this case, it is necessary to maintain detection precision to the same extent for each picture area even when shading as in FIG. 6 has occurred.

A conditional formula of the defective pixel detection when an output value has changed becomes the following Formula (7).

$$E ( i , j , t ) > \frac{β}{\sqrt{{S}_{typ} ( i , j )}} + {α}_{0} \qquad ( 7 )$$

If the whole of Formula (7) is multiplied by √S_{typ}(i,j)/√S_{std}, the following Formula (8) is obtained.

$$\sqrt{\frac{{S}_{typ} ( i , j )}{{S}_{std}}} \cdot E ( i , j , t ) > \frac{β}{\sqrt{{S}_{std}}} + \sqrt{\frac{{S}_{typ} ( i , j )}{{S}_{std}}} \cdot {α}_{0} \qquad ( 8 )$$

If Formula (5) is substituted into Formula (8) for rearrangement, the following Formula (9) is given.

$$\sqrt{\frac{{S}_{typ} ( i , j )}{{S}_{std}}} \cdot E ( i , j , t ) > {Eerror}_{0} + ( \sqrt{\frac{{S}_{typ} ( i , j )}{{S}_{std}}} - 1 ) \cdot {α}_{0} \qquad ( 9 )$$

If Formula (9) and Formula (6) are compared, it can be seen that the first evaluation value E is corrected using S_{typ} and S_{std} and the second term of the right side of Formula (9) is added in relation to specific noise. That is, the second evaluation value is calculated by multiplying the first evaluation value by the term including the square root of a ratio between the second output value and the standard output value. The second term of the right side of Formula (9) is the term in which a contribution rate increases when a change of S_{typ} with respect to S_{std} increases. Thereby, it is possible to change and evaluate a determination threshold value according to S_{typ} Also, S_{std} may be set so that √S_{typ} (i,j)/√S_{std} is necessarily less than 1 in the right side of Formula (9) in view of the balance between defective pixel detection precision and a calculation scale which are required. The following Formula (10) is an inequality indicating a minimum value S_{typ}_{_}ₘᵢₙ assumed in S_{typ} and a determination threshold value Eerror₀*. It is possible to perform evaluation by a fixed determination threshold value using Eerror₀* derived by Formula (10) in the right side of Formula (9)

$${Eerror}_{0} + ( \sqrt{\frac{{S}_{typ} ( i , j )}{{S}_{std}}} - 1 ) \cdot {α}_{0} > {Eerror}_{0} + ( \sqrt{\frac{{S}_{t yp \_ min}}{{S}_{std}}} - 1 ) \cdot {α}_{0} > {Eerror}_{0}^{*} \qquad ( 10 )$$

The defective pixel detection focused on one pixel has been described in this example, but a similar concept can also be applied to the case of the linear defective pixel detection illustrated in FIG. 7B and an application range is not limited to a range illustrated in FIG. 7B. Also, the representative value S_{typ} used when an evaluation value is calculated is set according to a defect detection pixel and a processing condition to improve the precision of normalization and the defective pixel detection precision. The processing condition is, for example, a color filter arranged on the pixel, a pupil part area through which a light beam received by the pixel passes, pixel addition, or the like.

In a defective pixel correction process, correction is performed by a bilinear method, a bi-cubic method, or the like using a pixel signal of a peripheral pixel with respect to a pixel detected by the defective pixel detection. By appropriately detecting and correcting defective pixels, high quality pictures can be provided. The defective pixel correction can be performed by a predetermined calculation method without using the information of the imaging optical system. Further, by performing hardware processing within the image processing device, defective pixel correction can be performed at a higher speed than software processing by an external device (PC or the like). Therefore, after the extraction of the defective pixel, the defective pixel correction process is executed within the imaging apparatus.

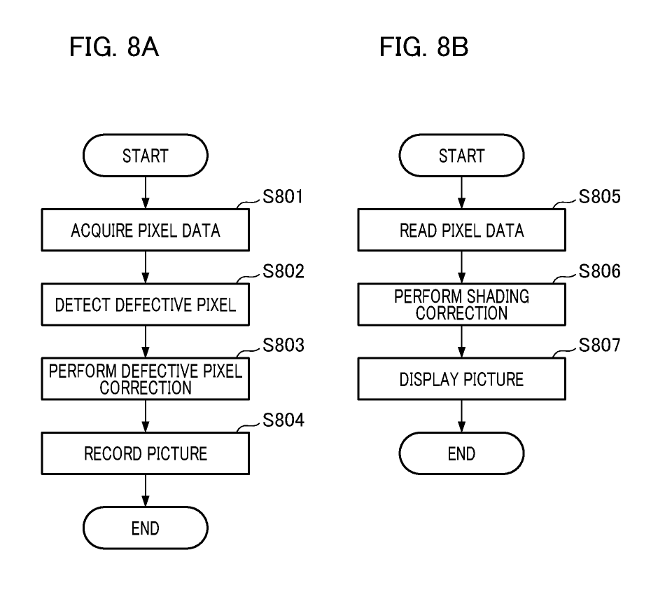

A process of generating a parallax picture will be described with reference to FIGS. 8A and 8B. FIGS. 8A and 8B are flowcharts illustrating a process of performing picture generation, picture recording, and picture displaying using pixel data when shading occurs. FIG. 8A is a flowchart illustrating a process from imaging to picture recording. FIG. 8B is a flowchart illustrating a process of reading recorded picture data and displaying a picture.

As described with reference to FIG. 2, it is possible to generate a parallax picture of a viewpoint having a different viewpoint from a captured picture by generating a picture using only sub-pixel data. However, if shading has occurred, it is necessary to perform defective pixel detection, defective pixel correction, and shading correction in an appropriate procedure so as to generate a high-quality picture by reducing an influence of the shading.

In S801 of FIG. 8A, a process of acquiring pixel data from sub-pixels of each pixel unit of the imaging element 107 is performed. In the next step S802, the CPU 121 performs defective pixel detection using the above-described conditional formula. A pixel for which the calculated evaluation value exceeds a predetermined determination threshold value is detected as a defective pixel. In S803, the CPU 121 performs defective pixel correction. A process such as linear interpolation using data of a pixel adjacent to a defective pixel is performed on a defective pixel detected in S802. For example, the defective pixel correction at an isolated point is performed by a bilinear method, a bi-cubic method, or the like using information of the pixel adjacent to the defective pixel. Also, adjacent defective pixel correction is performed if defective pixels are adjacent to each other. In S804, the CPU 121 performs control for recording picture data acquired from each of pixels including the pixel corrected in S803. For example, an image signal of a parallax picture is stored in a memory inside the device or an external memory.

The CPU 121 executes a process of reading pixel data from the memory in S805 of FIG. 8B and moves the process to S806. In S806, the CPU 121 acquires data necessary for shading correction and performs shading correction of the picture data acquired in S805. In the shading correction, picture data is corrected using a predetermined correction value table. For example, a case in which the picture processing circuit 125 generates a first parallax picture from an image signal A on the basis of pixel signals output from each of a plurality of photoelectric conversion units for each pixel unit by the imaging element and generates a second parallax picture from an image signal B is assumed. In this case, a correction value A corresponding to the image signal A and a correction value B corresponding to the image signal B are used. That is, because a shading correction value is different between the image signal A and the image signal B, it is necessary to separately use the shading correction value. Also, because the correction value changes according to an image height, correction values corresponding to different image heights are separately used. Further, because a shading correction value also changes according to an F number (an aperture value) and an exit pupil distance of a lens unit, the correction value according to the F number (the aperture value) and the exit pupil distance is used. In the lens exchange type camera system, the shading correction value is selected according to the lens device mounted on the camera body unit. The shading correction of the parallax picture is performed according to the correction value selected according to various types of conditions. In S807, the display unit 131 displays a picture according to an image signal on which the shading correction has been performed in S806.

In the present embodiment, it is possible to appropriately perform defective pixel detection on the basis of a luminance evaluation value normalized when shading has occurred. Consequently, it is possible to provide a high-quality picture on the basis of an image signal on which the defective pixel correction and the shading correction have been performed.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., CPU, micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a RAM, a ROM, a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-039156, filed Mar. 1, 2016, which is hereby incorporated by reference wherein in its entirety.

What is claimed is:

1. An image processing device for acquiring output values of a plurality of pixels and processing image signals, the image processing device comprising:
an acquisition unit configured to acquire a first output value from a pixel and acquire a second output value determined from a pixel adjacent to the pixel; and
a detection unit configured to perform defective pixel detection by calculating an evaluation value of the pixel from the first output value and the second output value and comparing the evaluation value with a threshold value,
wherein the detection unit calculates a second evaluation value using the second output value and a first evaluation value derived from the first output value and the second output value and detects the pixel as a defective pixel if the second evaluation value is greater than the threshold value.

2. The image processing device according to claim 1, wherein the detection unit calculates the second evaluation value by correcting the first evaluation value in a function including a standard output value of the defective pixel detection.

3. The image processing device according to claim 1, wherein the second output value is a median value or a mean value determined from an output value of a pixel adjacent to a target pixel.

4. The image processing device according to claim 1, wherein the detection unit determines the second output value using one or more of the first output value, a color filter of the pixel, a pupil area through which a received light beam passes, and the number of added pixels as the same condition.

5. The image processing device according to claim 1, wherein the pixel is a pixel of an imaging element including a plurality of microlenses and a plurality of photoelectric conversion units corresponding to the microlenses.

6. The image processing device according to claim 2,
wherein the first evaluation value is calculated by dividing a difference between the first output value and the second output value by the second output value, and
wherein the second evaluation value is calculated by multiplying a term which increases when the second value increases with respect to the standard output value by the first evaluation value.

7. The image processing device according to claim 6, wherein, when the first evaluation value is denoted by E(i,j,t) which is a function of a pixel position (i,j) and a photographing time (t), the standard output value is denoted by S_{std}(i,j) which is a function of the pixel position (i,j), the second output value is denoted by S_{typ}, and the threshold value is denoted by Eerror₀, and an allowed variation is denoted by α₀, the detection unit detects the pixel as the defective pixel if the pixel satisfies the following formula.
$$\sqrt{\frac{{S}_{typ} ( i , j )}{{S}_{std}}} \cdot E ( i , j , t ) > {Eerror}_{0} + ( \sqrt{\frac{{S}_{typ} ( i , j )}{{S}_{std}}} - 1 ) \cdot {α}_{0}$$

8. The image processing device according to claim 1, comprising:
a pixel correction unit configured to correct a pixel signal of the defective pixel detected by the detection unit.

9. The image processing device according to claim 8, comprising:
a shading correction unit configured to perform shading correction using the pixel signal corrected by the pixel correction unit.

10. The image processing device according to claim 9, wherein the shading correction unit performs shading correction of a parallax picture.

11. The image processing device according to claim 1, wherein the first evaluation value is a luminance evaluation value normalized in luminance.

12. An image processing device for acquiring output values of a plurality of pixels and processing image signals, the image processing device comprising:
an acquisition unit configured to acquire a first output value from a pixel and acquire a second output value determined from a pixel adjacent to the pixel;
a detection unit configured to perform defective pixel detection by calculating a first evaluation value of the pixel from the first output value and the second output value and comparing a second evaluation value calculated from the first evaluation value and the second output value with a threshold value;
a pixel correction unit configured to correct a pixel signal of a defective pixel detected by the detection unit; and
a shading correction unit configured to perform shading correction using the pixel signal corrected by the pixel correction unit.

13. The image processing device according to claim 12, wherein the shading correction unit acquires a correction value corresponding to an image height or a correction value corresponding to an aperture value or an exit pupil distance of a lens unit from a storage unit and performs shading correction during picture reproduction.

14. The image processing device according to claim 12, wherein the first evaluation value is a luminance evaluation value normalized in luminance.

15. A control method to be executed by an image processing device for acquiring output values of a plurality of pixels and processing image signals, the control method comprising:
acquiring a first output value from a pixel and acquiring a second output value determined from a pixel adjacent to the pixel; and
performing, by a detection unit, defective pixel detection by calculating an evaluation value of the pixel from the first output value and the second output value and comparing the evaluation value with a threshold value,
wherein the detection includes calculating, by the detection unit, a second evaluation value using the second output value and a first evaluation value derived from the first output value and the second output value and detecting the pixel as a defective pixel if the second evaluation value is greater than the threshold value.

16. A control method to be executed by an image processing device for acquiring output values of a plurality of pixels and processing image signals, the control method comprising:
acquiring a first output value from a pixel and acquiring a second output value determined from a pixel adjacent to the pixel;
performing, by a detection unit, defective pixel detection by calculating a first evaluation value of the pixel from the first output value and the second output value and comparing a second evaluation value calculated from the first evaluation value and the second output value with a threshold value;
correcting, by a pixel correction unit, a pixel signal of the detected defective pixel; and
performing, by a shading correction unit, shading correction using the pixel signal corrected by the pixel correction unit.
